(19) United States
(12) Patent Application Publication
(10) Pub. No.: US 2026/0323252 A1
(43) Pub. Date: Oct. 15, 2026

(54) ON-DEMAND RADIO FREQUENCY (RF) SENSING

(71) Applicant: QUALCOMM Incorporated, San Diego, CA (US)

(72) Inventors: Yuwei REN, Beijing, Beijing (CN); Weimin DUAN, San Diego, CA (US); Huilin XU, Temecula, CA (US)

(21) Appl. No.: 19/101,200

(22) PCT Filed: Nov. 4, 2022
(86) PCT No.: PCT/CN2022/129823

§ 371 Date: Feb. 4, 2025

(51) Int. Cl. H04W 4/38; H04L 5/00

(52) U.S. Cl. CPC H04W 4/38; H04L 5/0048

(57) ABSTRACT

In some implementations, a sensing server may, responsive to obtaining an on-demand sensing request, send a message to a base station, wherein the message includes an indication of a prospective reference signal (RS) configuration for the radio frequency (RF) sensing. The sensing server may receive, from the base station, a response to the message, wherein the response is indicative of whether the prospective RS configuration can be supported for the RF sensing. The sensing server may send an RS configuration from to the one or more sensing nodes, wherein: sending the RS configuration is based at least in part on the response, and the RS configuration includes one or more values for one or more RS parameters for use by the one or more sensing nodes to perform the RF sensing.

### BACKGROUND

### 1. Field of Disclosure

The present disclosure relates generally to the field of radiofrequency (RF)-based sensing, or simply “RF sensing” in a wireless network such as a cellular network.

### 2. Description of Related Art

As the sophistication of cellular networks such as fourth-generation (4G) and fifth-generation (5G) cellular networks continues to increase, the functionality of such networks expands beyond mere data communication. Cellular networks can, for example, provide positioning functionality to determine a geographical location of a cellular mobile device (known as a “user equipment” (UE)) within a coverage region of the cellular network. Further, such networks are expanding into RF sensing to be able to detect the objects (including their location and speed) from reflections (or echoes) of RF signals off of the objects. However, RF signals used for RF sensing are often transmitted in an inefficient way, leading to increased power usage and overhead.

### BRIEF SUMMARY

An example method of enabling on-demand radio frequency (RF) sensing by one or more sensing nodes, according to this disclosure, may comprise responsive to obtaining an on-demand sensing request at a sensing server, sending a message from the sensing server to a base station, wherein the message includes an indication of a prospective reference signal (RS) configuration for the RF sensing. The method also may comprise receiving, at the sensing server from the base station, a response to the message, wherein the response is indicative of whether the prospective RS configuration can be supported for the RF sensing. The method also may comprise sending an RS configuration from the sensing server to the one or more sensing nodes, wherein: sending the RS configuration is based at least in part on the response, and the RS configuration includes one or more values for one or more RS parameters for use by the one or more sensing nodes to perform the RF sensing.

An example method of enabling on-demand radio frequency (RF) sensing by one or more sensing nodes, according to this disclosure, may comprise receiving, at a base station from a sensing server, a message including an indication of a prospective reference signal (RS) configuration for the RF sensing. The method also may comprise sending, from the base station to the sensing server, a response to the message, wherein the response is indicative of whether the prospective RS configuration can be supported for the RF sensing. The method also may comprise receiving an RS configuration from the sensing server, wherein: the receiving of the RS configuration is based at least in part on the response, and the RS configuration includes one or more values for one or more RS parameters for use by the one or more sensing nodes to perform the RF sensing.

An example sensing server comprising: a transceiver, a memory, one or more processors communicatively coupled with the transceiver and the memory, wherein the one or more processors are configured to, responsive to obtaining an on-demand sensing request, send a message via the transceiver to a base station, wherein the message includes an indication of a prospective reference signal (RS) configuration for radio frequency (RF) sensing. The one or more processors further may be configured to receive, via the transceiver from the base station, a response to the message, wherein the response is indicative of whether the prospective RS configuration can be supported for the RF sensing. The one or more processors further may be configured to send an RS configuration via the transceiver to one or more sensing nodes, wherein: sending the RS configuration is based at least in part on the response, and the RS configuration includes one or more values for one or more RS parameters for use by the one or more sensing nodes to perform the RF sensing.

An example base station comprising: a transceiver, a memory, one or more processors communicatively coupled with the transceiver and the memory, wherein the one or more processors are configured to receive, via the transceiver from a sensing server, a message including an indication of a prospective reference signal (RS) configuration for radio frequency (RF) sensing. The one or more processors further may be configured to send, via the transceiver to the sensing server, a response to the message, wherein the response is indicative of whether the prospective RS configuration can be supported for the RF sensing. The one or more processors further may be configured to receive an RS configuration via the transceiver from the sensing server, wherein: the receiving of the RS configuration is based at least in part on the response, and the RS configuration includes one or more values for one or more RS parameters for use by one or more sensing nodes to perform the RF sensing.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is a diagram of an architecture 200 used to perform RF sensing, according to embodiments herein.

FIG. 3 is a diagram illustrating a simplified environment in which beamforming is performed.

FIG. 4 is a simplified diagram of a configuration illustrating how standard approaches for RF sensing can be inefficient.

FIG. 5 is a timing graph illustrating further latency issues that may arise with a static RS signal configuration for RF sensing.

FIG. 6 is a message flow diagram illustrating a general method of on-demand RF sensing, according to some embodiments.

FIGS. 7A and 7B are message flow diagrams illustrating additional methods for performing RF sensing, according to some embodiments.

FIG. 8 is a message flow diagram illustrating in additional method for performing RF sensing, according to some embodiments.

FIG. 9 is a table listing information element (IEs) that may be included in an on-demand sensing request, according to some embodiments.

FIGS. 10A and 10B are illustration of an example timing diagrams in which RS may be transmitted in response to on-demand requests, according to some embodiments.

FIGS. 11A-11C are message flow diagrams illustrating examples of different options that embodiments may employ for exchanging on-demand RF sensing capability information.

FIG. 12 is a diagram illustrating an example of how on-demand sensing may be performed in a particular scenario, according to some embodiments.

FIGS. 13A-13C are message flow diagrams illustrating different options for how this exchange between the base station and sensing server may be performed, according to some embodiments.

FIG. 14 is an illustration of a table showing an example of how the content of acknowledgment (ACK) and negative acknowledgment (NACK) messages provided by a base station to a sensing server, as described herein, may vary according to some embodiments

FIG. 15 is a flow diagram of a method of enabling on-demand RF sensing by one or more sensing nodes, according to an embodiment.

FIG. 16 is a flow diagram of another method of enabling on-demand RF sensing by one or more sensing nodes, according to an embodiment.

FIG. 17 is a block diagram of an embodiment of a sensing node.

FIG. 18 is a block diagram of an embodiment of a base station.

FIG. 19 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IOT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “sensing reference signals,” “reference signals for sensing,” and the like may be used to refer to signals used for RF sensing (also generically referred to herein as “sensing”) as described herein. A signal used for RF sensing may be generally referred to herein as a reference signal (RS). As described in more detail herein, such signals may comprise any of a variety of signal types but may not necessarily be limited to signals solely used for RF sensing.

As previously noted, RF sensing is being contemplated for use in wireless networks, including cellular networks. However techniques this far have contemplated using “always on” RF signals. This can lead to unnecessary overhead, inefficient use of energy/RF resources, and the like. Moreover, this can lead to a static resource allocation for RF sensing in instances where a different number of resources (greater or fewer) may be more suited for a given instance of the RF sensing. Embodiments herein address these and other user issues by allowing for “on-demand” RF sensing that can provide for an efficient use of resources, reduced latency, and/or other such advantages. Additional details will be provided after a review of applicable technology.

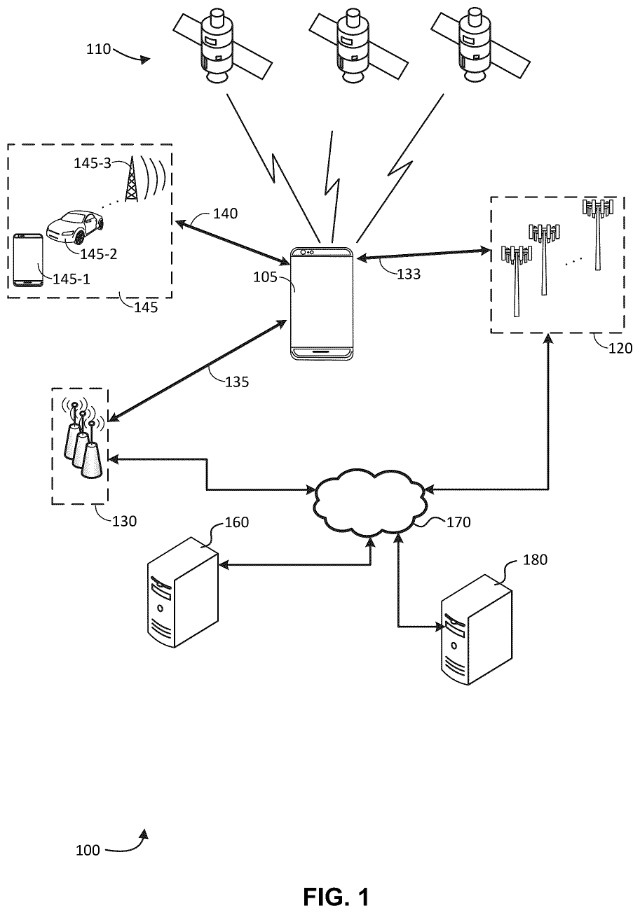

FIG. 1 is a simplified illustration of a wireless system capable of communication, positioning, and sensing, referred to herein as a “communication/positioning/sensing system” 100 in which a mobile device 105, network function server 160, and/or other components of the communication/positioning/sensing system 100 can use the techniques provided herein for on-demand RF sensing, according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a network function server 160, which may operate as a location server. In some embodiments, satellites 110 used for NTN-based positioning may be different than those used for GNSS-based positioning. In some embodiments NTN notes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an OFDM waveform to allow both RF sensing and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSs)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

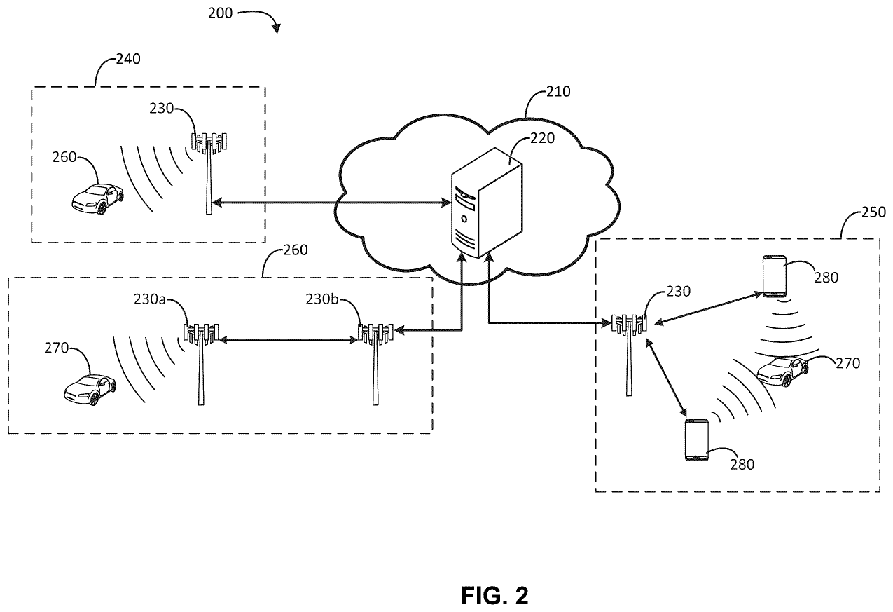

FIG. 2 is a diagram of an architecture 200 used to perform RF sensing, according to embodiments herein. Components include a network 210 comprising a sensing server 220, which is in communication with one or more base stations 230. The architecture 200 further illustrates different configurations 240, 250, and 260 for RF sensing, any or all of which may be utilized in a given embodiment. In a first configuration 240, a base station 230 acts as a sensing node to perform sensing of a target 270. (Although illustrated as vehicles, targets 270 may comprise any objects detectable via RF sensing.) In a second configuration 250, a base station 230 is in communication with other devices 280 (e.g., mobile devices or other wireless devices), which act as sensing nodes to perform sensing of a target 270. In ⅓ configuration 260, a first base station 230 a acts as a sensing node to perform sensing of a target 270, and a second base station 230b acts as a accessing point for the first base station 230a, enabling communications between the first base station 230a and the sensing server 220.

Although three configurations 240, 250, and 260 are provided in FIG. 2, additional or alternative configurations may be utilized. More broadly, depending on desired functionality, any combination of base stations 230 and/or other devices 280 may act as sensing nodes to perform sensing of a target 270. As such, sensing nodes may comprise base stations 230 and/or other devices 280. Base stations may additionally or alternatively act as accessing nodes to sensing nodes (other devices 280 and/or base stations 230). Again, RF sensing may be implemented by sensing nodes using monostatic, bistatic, and/or multi-static sensing.

In FIG. 2, the architecture 200 may correspond with aspects of the communication/positioning/sensing system 100 of FIG. 1 related to RF sensing. For example, the sensing server 220 may correspond to a network function server 160 of FIG. 1 (e.g., an SMF), and network 210 we correspond with network 170 (e.g., a 5G or 6G cellular network). Base stations 230 may correspond with base stations 120, and other devices 280 may correspond with wireless devices in FIG. 1 (e.g., mobile device 105, mobile devices 145, APs 130, satellites 110, or any combination thereof). Thus, the architecture 200 may be implemented by a communication/positioning/sensing system 100 and/or another system capable of enabling wireless communication and/or wireless positioning.

Broadly put, the sensing server 220, may comprise a server executed in the network 210 to implement RF sensing. As such, the sensing server 220 may be responsible for the overall sensing management, including the sensing configuration and the processing for detection of targets 270. For example, the sensing server 220 may coordinate with one or more base stations 230 to configure the sensing resources to the sensing nodes. The sensing server 220 may additionally or alternatively trigger the sensing nodes to perform RF sensing, receive reporting from each of the sensing nodes, collect the sensing reporting from the sensing nodes, detect/identify/track targets based on the sensing reporting, or any combination thereof. Sensing nodes may perform the sensing actions, including transmission and/or reception of sensing RS, and report the sensing information (e.g., measurements of sensing RS and/or information derived therefrom, such as extracted feature information and/or target information like location, speed, etc.). Performing the sensing actions and/or reporting of the sensing information may be in accordance with the sensing configuration received from the sensing server 220. Base stations 230 may act as sensing nodes and/or may act as access points to convey information between location server 220 and sensing nodes (e.g., other devices 280). This may include conveying configuration information from location server 220 to sensing nodes and/or conveying sensing information (reporting) from sensing nodes to location server 220.

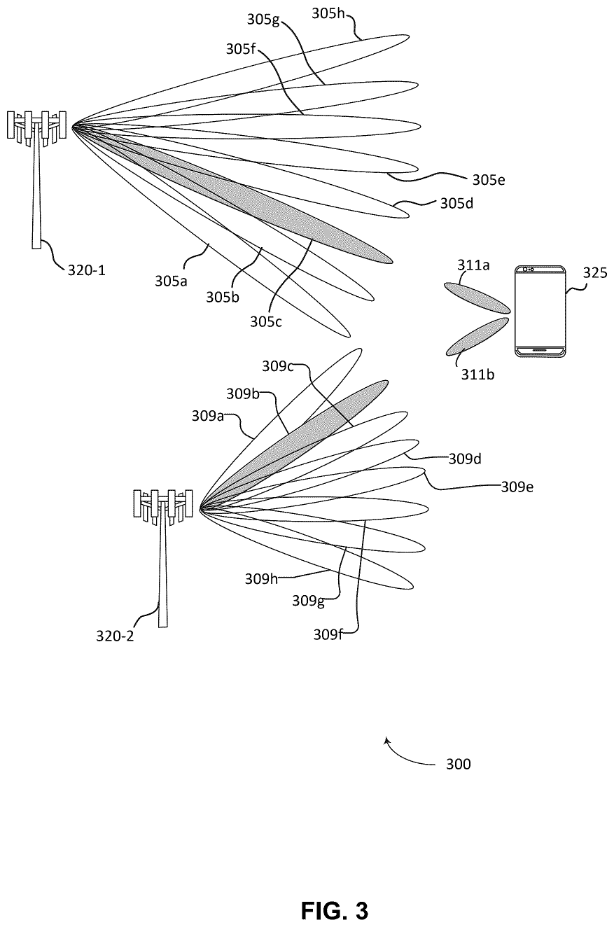

FIG. 3 is a diagram illustrating a simplified environment 300 including two base stations 320-1 and 320-2 (which may correspond to base stations 120 of FIG. 1) with antenna arrays that can perform beamforming to produce directional beams for transmitting and/or receiving RF signals. FIG. 3 also illustrates a mobile device 325, which may also use beamforming for transmitting and/or receiving RF signals. Such directional beams are used in 5G NR wireless communication networks (and likely used in future generations of wireless communication networks) for communication, positioning, RF sensing, or any combination thereof. Each directional beam may have a beam width centered in a different direction, enabling different beams of a base station 320 to correspond with different areas within a coverage area for the base station 320.

Different modes of operation may enable base stations 320-1 and 320-2 to use a larger or smaller number of beams. For example, in a first mode of operation, a base station 320 may use 16 beams, in which case each beam may have a relatively wide beam width. In a second mode of operation, a base station 320 may use 64 beams, in which case each beam may have a relatively narrow beam width. Depending on the capabilities of a base station 320, the base station may use any number of beams the base station 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the mobile device 325 may be capable of using different numbers of beams, which may also correspond to different modes of operation, signal types, etc.

In some situations, a base station 320 may use beam sweeping. Beam sweeping is a process in which the base station 320 may send an RF signal in different directions using different respective beams, often in succession, effectively “sweeping” across a coverage area. For example, a base station 320 may sweep across 120 or 360 degrees in an azimuth direction, for each beam sweep, which may be periodically repeated. Each direction beam can include an RF reference signal (e.g., an RS resource), where base station 320-1 produces a set of RF reference signals that includes Tx beams 305a, 305b, 305c, 305d, 305e, 305f, 305g, and 305h, and the base station 320-2 produces a set of RF reference signals that includes Tx beams 309a, 309b, 309c, 309d, 309e, 309f, 309g, and 309h. As noted, because mobile device 325 may also include an antenna array, it can receive RF reference signals transmitted by base stations 320-1 and 320-2 using beamforming to form respective receive beams (Rx beams) 311a and 311b. Beamforming in this manner (by base stations 320 and optionally by mobile devices 325) can be used to make functions like communications, positioning, and RF sensing more efficient. The directionality of beams also can be helpful in performing measurements for position determination (e.g., AoD and AoA measurements).

As previously noted, approaches to RF sensing in a wireless network, such as a 5G NR network, have been inefficient. In order to detect the target and simplify the procedure, generally, the sensing resource is thought of as an always-on broadcast mode configured with a periodic pattern. But the resource cost can be very large when high resolution is required. In other words, because sensing resolution is partially proportional to the resource cost, increased resolution typically comes with increased resource use.

Further, traditional procedures for requesting a periodic or static sensing lack the flexibility to support low latency and the low resource cost within the sensing measurements and processing, making it challenging to update the sensing RS configuration on the fly when required, which has implications on the sensing accuracy (type of physical layer configurations) and latency (time taken to request a new sensing RS configuration) of the range/doppler estimation.

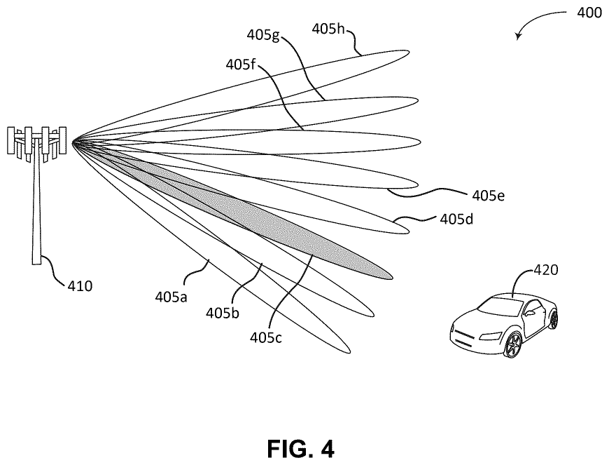

FIG. 4 is a simplified diagram of a configuration 400 illustrating how standard approaches for RF sensing can be inefficient. Here, various beams 405a-405h are transmitted by a base station 410, and may be used to detect an target 420. According to traditional approaches for RF sensing, however, a sensing RS is transmitted in all directions via beam sweeping, sweeping across beams 405a-405h. However, from a network perspective, beam sweeping in this manner results in sensing RS beam-based transmissions that are not relevant for the calculation of the target estimation. In the configuration 400, for example, beam 405c may be relevant, but other beams may not be. Moreover, for a moving target 420, sensing may only be relevant during a period of time in which the target 420 is within an area or volume in which the base station 410 can detect targets via RF sensing. Even so, traditional approaches for RF sensing may use all beams when only a subset of beams may be needed, and/or may perform beam sweeping when no targets are in RF sensing range. Thus, as described herein below, embodiments may implement use scanning times and/or beams more efficiently (e.g., omitting at least some nonrelevant beams and/or times) to help reduce network overhead.

With respect to RF sensing, a two-stage procedure is considered to improve the efficiency of the sensing. One stage is to detect potential targets, where one sparse resource pattern might be configured. But the accuracy might be very low. Once a target is detected, the second stage may be triggered with high dense resource pattern to increase accuracy. But even though the two-stage procedure can largely reduce the resource cost, it still may be considered and “always-on” signal configuration. That is, resource cost and latency maybe high/inefficient, especially for the sparse target scenarios.

Various challenges exist for an “always-on” RS signal configuration for RF sensing. For example, it may result in unnecessary overhead, waste of energy, etc. in the case that no sensing is required during a particular time or in a particular area of a network. Further, in the case of beamformed sensing RS (e.g., as illustrated in the configuration 400 of FIG. 4), such RS transmission in all beam-sweeping directions may result in an unnecessary transmission of sensing resources. Moreover, such RS signal configuration may utilize a static allocation of sensing resources that does not allow for a temporary increase of the sensing RS resources for meeting higher sensing accuracy and/or lower latency sensing requirements in certain areas or at certain times. Equivalently, a static sensing RS resource allocation does not allow for a decrease of sensing RS resources in case the sensing requirements can be met with fewer sensing RS resources.

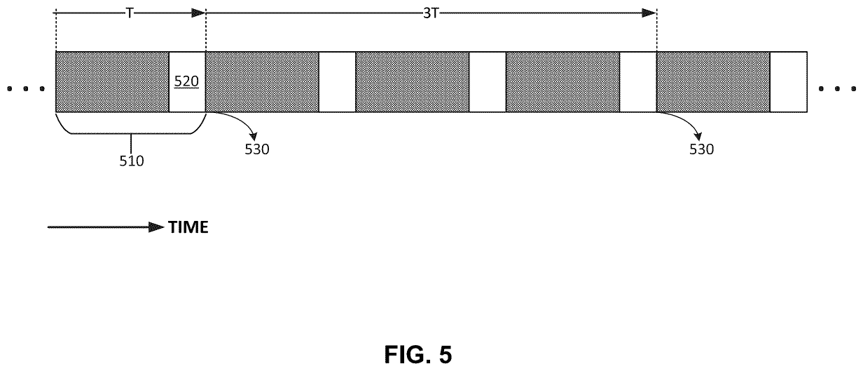

FIG. 5 is a timing graph illustrating further latency issues that may arise with a static RS signal configuration for RF sensing. In this example, an observation window 510 has a length T and comprises a sensing period 520 during which sensing is performed (RS are transmitted and reflected signals are received), after which a report of the sensing is provided (shown by arrows 530). The observation pattern illustrated in FIG. 5 may represent, for example, a detection stage in a two-stage procedure comprising detecting and tracking stages.

As illustrated, the window 510 is repeated in an unchanging (static) fashion. Because Doppler resolution is proportional to the observation window, the sensing performed in the example of FIG. 5 has a single Doppler resolution. Further, because Doppler utilizes multiple sensing periods, report may be provided after the multiple sensing periods, which can also help reduce reporting overhead but may also increase latency. (In the example of FIG. 5, the latency of the reporting is 3 T.) Further, because a static pattern has a fixed window length (T), the window length may be selected to help ensure Doppler granularity. Once the target is detected using this pattern, a tracking stage may be implemented in which additional resources are used can provide higher accuracy/resolution (e.g., reducing window length T, increasing reporting periodicity, etc.).

To briefly summarize some issues with traditional RF sensing as previously described with respect to FIGS. 4-5, periodic/static sensing procedures may not be efficient. In particular, they may waste resources through access beam usage and/or performing sensing unnecessarily (e.g., even when no target has been detected long time). Although a sparse pattern of static RF sensing can limit resource cost, it can also lead to relatively large latency and low accuracy.

Embodiments herein address these and other issues by providing for an on-demand sensing functionality to optimize the sensing procedure. As used herein, on-demand sensing refers to a sensing capability that allows the system to request RF sensing and/or a change in available sensing configuration, which may be based on real-time sensing scenarios and/or application requirements. The dynamic nature of on-demand sensing over the current (static/periodic) mechanism, would allow the sensing server (e.g., SMF) and sensing nodes to react and respond to changes in the radio environment, e.g. non-line-of-sight (NLOS) effects, target moving, etc. On-demand is sensing functionality, as described in more detail hereafter, may provide one or more of the following benefits:
Efficiency: On-demand functionality can avoid unnecessary overhead, waste of energy, etc. in instances in which no sensing is needed during a particular time or in a particular area of a network (e.g., no targets of interest are present). In instances in which RF sensing utilizes beamforming, on-demand RF sensing as provided herein can provide the accurate beam coverage in the sensing, avoiding the overhead of transmitting RS on irrelevant beams.
Latency: On-demand RF sensing can help avoid current periodical pattern configuration that may not be sufficient to meet the response time requirements; e.g., traditional RF sensing patterns may have too large of a periodicity in one sparse pattern. On-demand RF sensing as provided herein can enable a dense RS pattern for sensing, and the periodicity may be relatively small with little latency.
Accuracy: Un-demand RF sensing can further help avoid current periodical sensing resource configurations that may not be sufficient to meet the accuracy requirements; e.g., may have a too small bandwidth, too few repetitions, etc. Triggering the on-demand sensing can provide the associated resource configuration for one specific sensing request.

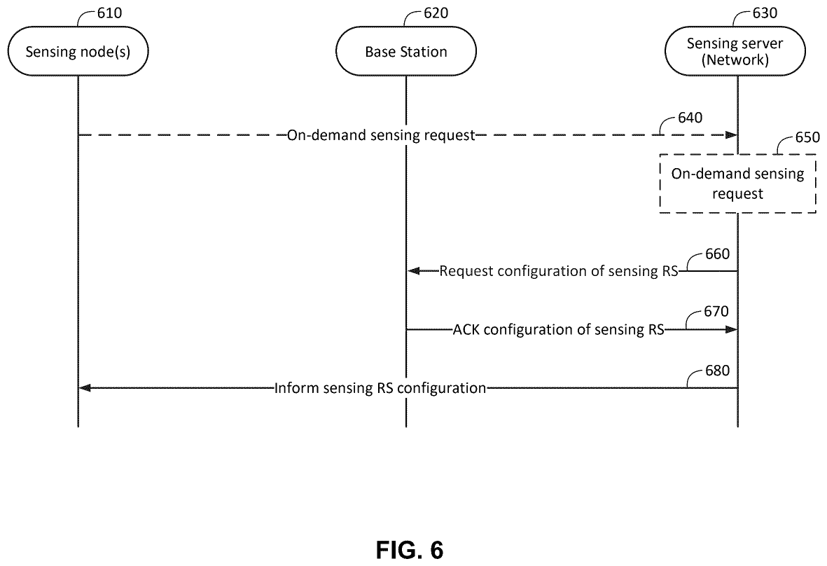

FIG. 6 is a message flow diagram illustrating a general method of on-demand RF sensing, according to some embodiments. Here, messaging takes place between one or more sensing nodes 610, a base station 620 (acting as an access point to the sensing node(s) 610, in this embodiment), and a sensing server 630. Communications between the sensing node(s) 610 and sensing server 630 may be relayed by the base station 620 (and, in some embodiments, other intervening devices that are not shown in FIG. 6). Sensing node(s) 610 may comprise one or more mobile devices (e.g., UEs) and/or one or more additional base stations.

Although on-demand sensing may be performed in a standalone mode (e.g., without traditional/legacy sensing), some embodiments may enable on-demand sensing to be performed in addition to traditional/legacy sensing to enhance the traditional/legacy sensing. As such, some embodiments of the procedure shown in FIG. 6 may be performed in conjunction with traditional/legacy sensing, in which case sensing node(s) 610 may be configured with a sparse sensing resource (e.g., in which case sensing may be performed prior to and/or after the procedure shown in FIG. 6). The on-demand sensing may be used in addition with this sparse sensing resource to enhance the traditional/legacy sensing.

On-demand RF sensing may comprise one of two modes: a sensing-node-initiated mode and a network-initiated mode, each of which are reflected in FIG. 6. These alternative modes are represented by dashed arrow 640 and dashed block 650. Arrow 640 represents the sensing-note-initiated mode, in which a sensing node 610 sends an on-demand sensing request to the sensing server 630. This may be triggered, for example, by an application executed at the sensing node 610, a user request, or the like. Alternatively, the network-initiated mode may be initiated at the sensing server 630, as indicated at block 650. The network-initiated be triggered by a network function, a request from an (e.g., authorized) external entity, or the like.

According to some embodiments, the on-demand sensing request—by either the sensing node 610 or the sensing server 630—can include a request for one or more specific aspects of RS to use for sensing. For example, in on-demand sensing requests may include a request, suggestion, or recommendation for a specific resource pattern, toggling RS transmissions on/off, adjusting periodicity, designating bandwidth, or any combination thereof.

The sensing server 630 may then send a request configuration of sensing RS to a base station 620, as indicated at arrow 660. Here, the request configuration of sensing RS may include an indication of a desired/prospective RS sensing configuration to perform sensing (which may be based on a request/suggestion/recommendation received in the on-demand sensing request at arrow 640), to see if the base station 620 can support such a configuration. (This support can comprise, for example, the base station 620 transmitting and/or receiving sensing RS in accordance with the configuration.) If so, the base station 620 will respond to the sensing server 630 with an acknowledgment (ACK) of the configuration of sensing RS, as indicated at 670. With the support of the base station 620 confirmed, the sensing server 630 may then send the sensing RS configuration to the sensing node(s) 610, as indicated arrow 680. Again, an RS configuration may include information for the sensing node(s) 610 to use for RF sensing, including which resources (e.g., time and/or frequency resources) may be used to transmit and/or receive sensing RS.

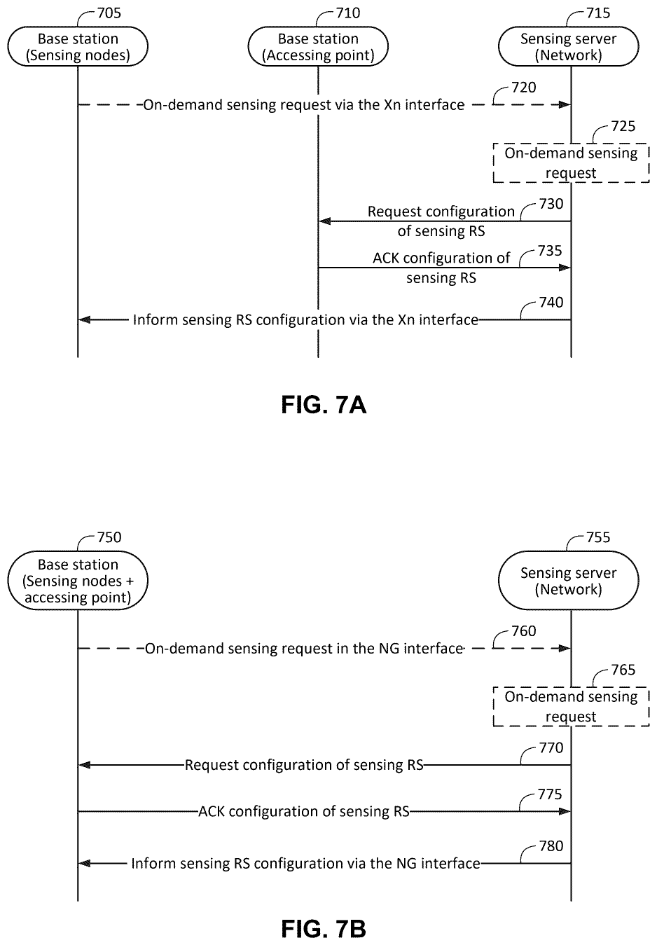

FIGS. 7A and 7B are message flow diagrams illustrating additional methods for performing RF sensing, according to some embodiments. FIGS. 7A and 7B can be seen as variations to FIG. 6 in which a base station acts as a sensing node. Here, the configuration in FIG. 7A may correspond with configuration 260 of FIG. 2, where communication is between a first base station 705 acting as a sensing node, a second base station 710 acting as an accessing point, and a sensing server 715. The operations at 720-740 may be similar to counterpart operations 640-680 of FIG. 6, as previously described. Here, however, communications between the first base station 705 and second base station 710 may take place via an Xn interface between base stations (e.g., in a Radio Access Network (RAN) of a cellular network). Communications between the second base station 710 and sensing server 755 may take place via an NG interface between base stations (in a RAN) and components in a core network (e.g., a 5GC).

The configuration in FIG. 7B may correspond with the configuration 240 of FIG. 2, where a single base station 750 acts as a sensing node and accessing point in communication with a sensing server 755. Again, operations 760-780 may be similar to counterpart operations 640-680 of FIG. 6, as previously described. Here, however, the single base station 750 may perform the functions of both sensing nodes and accessing point. Further, communications between the base station 750 and sensing server 755 may take place via an NG interface between base stations and components in a core network.

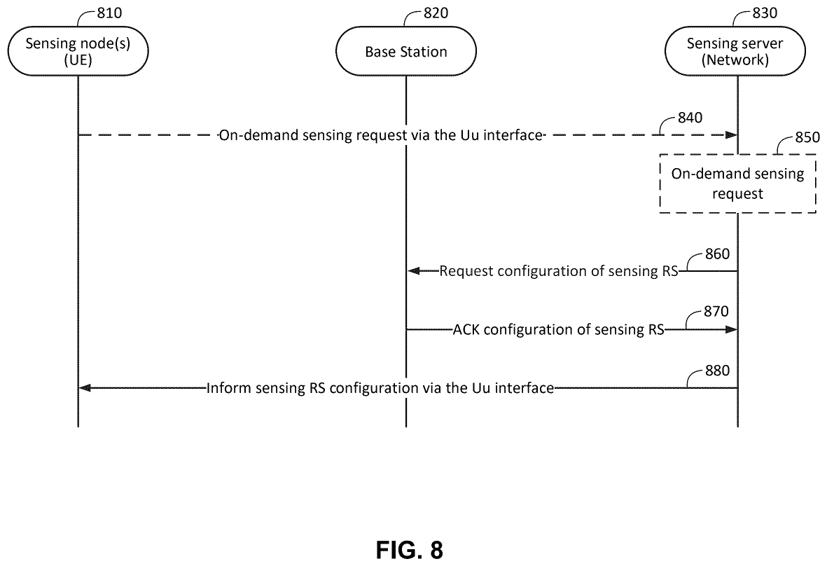

FIG. 8 is a message flow diagram illustrating in additional method for performing RF sensing, according to some embodiments. FIG. 8 can be seen as a variation to FIG. 6 in which a base station acts as a sensing node. Here, the configuration in FIG. 7A may correspond with configuration 250 of FIG. 2, where communication is between a UE sensing node(s) 810, a base station a 20 acting as an accessing point, and a sensing server 830. The operations at 840-880 may be similar to counterpart operations 640-680 of FIG. 6, as previously described. Here, however, communications between the UE sensing node(s) 810 may take place via a wireless Uu interface, for example. (Again communications between the base station 820 and sensing server 830 may take place via an NG interface between base stations and components in a core network.)

In FIG. 8, there may be some additional differences between previously-described embodiments. For example, because the base station 620 may act as an accessing point to relay communication between the sensing node(s) 610 and sensing server 630, according to some embodiments, a sensing node 610 comprising a UE in a cellular network (e.g., LTE or NR) may need to be in an RRC_CONNECTED state. According to some embodiments, because the sensing server 830 may schedule RF sensing for multiple sensing nodes (e.g., in addition to the sensing node(s) 810) many of which may send separate on-demand sensing requests), the sensing server 830 may determine an RS configuration with all requests in mind, thereby potentially optimizing RF sensing across multiple sensing node(s) 810 (e.g., ensuring available resources, enabling multi-sensing-node sensing (e.g., multi-static sensing), etc.). Additionally or alternatively, the base station 820 may control and/or manage the sensing procedure of the sensing node(s) 810 at least in part by configuring and enabling the RF sensing resources (e.g., which may be in accordance with the RS configuration).

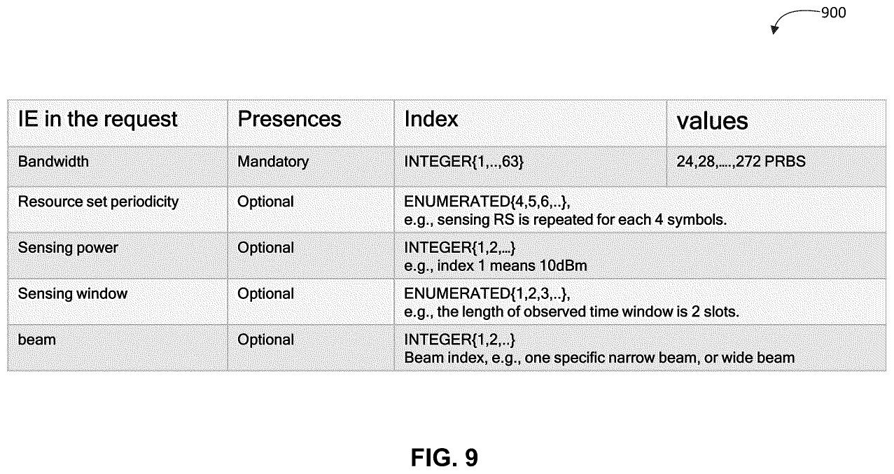

It can be noted that the content and/or formatting of the messaging described with respect to FIGS. 6-8 may vary, depending on governing messaging standards and/or protocols, desired functionality, other factors, or a combination thereof. Examples of what may be included in at least some of this messaging are provided hereafter with respect to FIG. 9.

FIG. 9 is a table 900 listing information element (IEs) that may be included in an on-demand sensing request (e.g., as shown at arrows 640 of FIGS. 6, 720 of FIGS. 7A, 760 of FIG. 7B, and 840 of FIG. 8). In the table 900, the bandwidth may comprise a requested bandwidth for a sensing resource (e.g., RS). The resource set periodicity may determine (e.g., resource density) the number of effective measurement occasions. (The higher the density, the higher the accuracy.) The sensing power may determine the coverage range of the sensing (bearing in mind that larger power might cause interference for other devices). The sensing window may be associated with Doppler granularity (e.g., as previously described with respect to FIG. 5). Further, there may be a phase continuity setting among the resources (e.g., enabling phase to be determined between two successive RS resources).

It should be noted that IEs for a given environment may not be limited to those listed in the table 900. As further provided in the table 900, each IE may be mandatory or optional in the request, be associated with an index (e.g., where index numbers/integers correspond to predetermined values, to help reduce the size of the non-demand request), have actual values (e.g., as indicated in the table 900), or any combination thereof. Moreover, as previously noted, the different values for the IEs (bandwidth, periodicity, etc.) may be recommendations (e.g., a recommended sensing resource configuration), or requirements, depending on desired functionality. Additionally or alternatively, some IEs may have default values

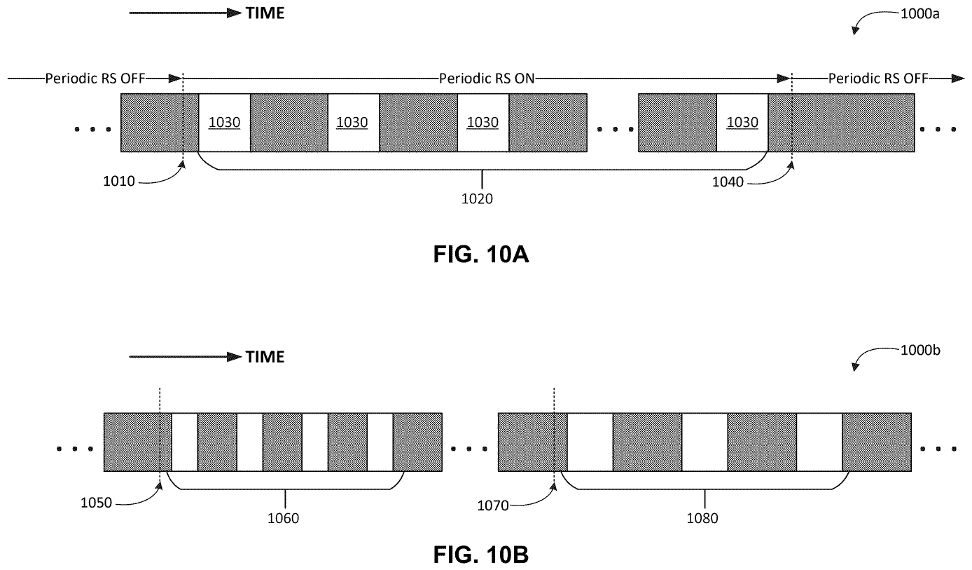

According to some embodiments, the on-demand sensing may be based on periodic RS, semi-persistent RS, or aperiodic RS transmission. As such, embodiments may define these three types of RS and the related information that may be used in an on-demand sensing request. For example, periodic or semi-persistent RS may have a preset periodicity and/or offset, which may be switched on and off via an on-demand sensing request. In contrast, aperiodic sensing RS transmission may be more flexible in time and may be requested at any indicated time. Examples of how these types of RS may be used for on-demand sensing are provided hereafter with respect to FIGS. 10A and 10B. The transmission of the RS may be based on an RS configuration provided by a sensing server to sensing nodes (e.g., as previously described).

FIG. 10A illustrates an example timing diagram 1000a in which periodic RS or semi-persistent RS is toggled based on on-demand requests (e.g., from sensing node to a sensing server). In this example an on-demand request is sent at a first time 1010 to the sensing server to toggle the periodic RS from “OFF” to “ON,” triggering a subsequent period of time 1020 during which RS is periodically transmitted (and received). The periodicity and/or offset of the RS may be preset and/or may be requested in the on-demand request. In FIG. 10A, RF sensing (RS transmission and reception) occurs during periods 1030. The period of time 1020 during which RS is periodically transmitted may proceed until a second on-demand request is sent at a second time 1040. This type of on-demand sensing can be beneficial, for example, when a target enters cell coverage of a base station (at which point the RS may be turned “ON”) and later moves out of cell coverage (at which point the RS may be turned “OFF”). Turning the RS of (e.g., when sensing is a low priority or when there are no interesting targets)

FIG. 10B illustrates a second example timing diagram 1000b in which aperiodic RS is triggered by on-demand requests. In this example, a first on-demand request is sent at a first time 1050 to the sensing server, activating a first set of RS 1060. Parameters of the first set of RS 1060, including power, periodicity, start and/or end times for the set of RS, and so forth, may be included in the request sent by the sensing node. After the first set of RS 1060, the transmission of RS may be stopped until another on-demand request is received. In the example of the timing diagram 1000b, a second on-demand request is sent at a second time 1070, triggering a second set of RS 1080. Because the second on-demand request may include a different set of parameters, the parameters for the second set of RS 1080 may be different than those of the first set of RS 1060.

According to some embodiments, the on-demand sensing requests described herein may follow an exchange of capability information to determine whether sensing nodes are capable of supporting on-demand sensing. Generally put, there may be a wide variety of sensing RS-related capabilities that reflect the node sensing process, sensing measurement, storage capability. This information may be provided in a capability message sent from a sensing node to a sensing server, which may be responsive to a request from the sensing server for capability information.

According to some embodiments, on-demand sensing capability may be included in a capability message. In one embodiment, on-demand sensing may be included in a single bit, indicating whether or not on-demand sensing is supported. According to some embodiments, other capability related to on-demand sensing may be included, such as the maximum power in the sensing, the maximum bandwidth, the maximum number of the detected/tracked targets simultaneously, or a combination thereof.

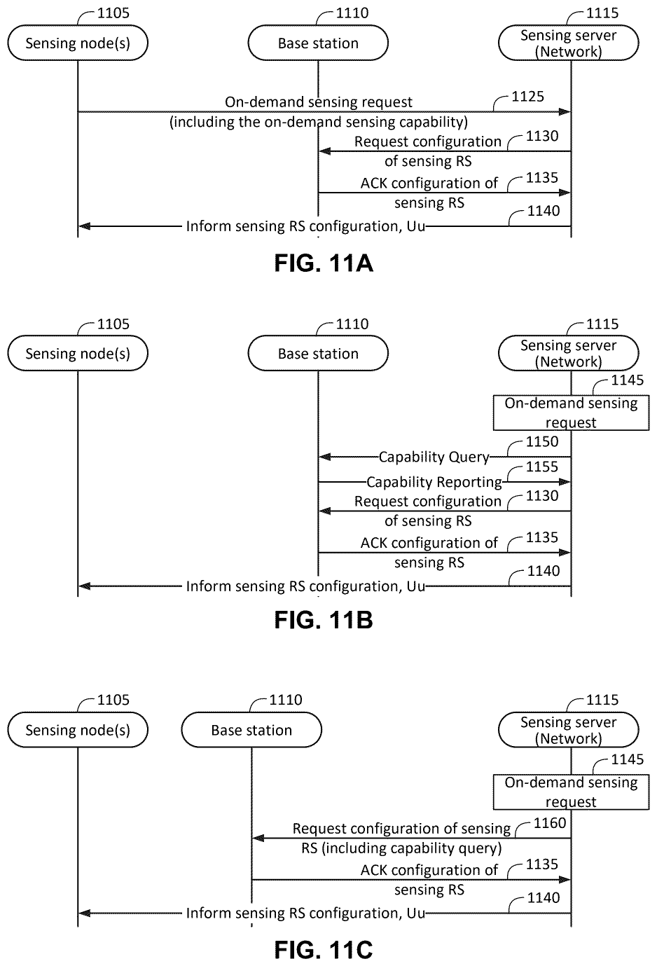

FIGS. 11A-11C are message flow diagrams illustrating examples of different options that embodiments may employ for exchanging such capability information. FIG. 11A illustrates an example of a first option in which on-demand sensing is triggered by sensing node(s) 1105. Here, sensing node(s) 1105 sends an on-demand sensing request, shown by arrow 1125, via a base station 1110 (e.g., acting as an access node) to a sensing server 1115. (These entities may correspond to sensing nodes/base stations/sensing servers as described in previously-discussed embodiments, including in FIGS. 6-8.) This results in operations including (i) the sensing server 1115 sending a configuration request of sensing RS to the base station 1110, shown by arrow 1130; (ii) the base station acknowledging the configuration, shown by arrow 1135; (iii) in the sensing server 1115 sending the RS configuration to the sensing node(s) 1105 (via a Uu link between the sensing node(s) 1105 and the base station 1110). As can be seen, the processes similar to the general process of on-demand sensing illustrated in FIG. 6, and the actions shown at arrows 1125-1140 may be executed as previously described with respect to FIG. 6. Here, however, on-demand sensing capability is provided by the sensing node(s) 1105 in the on-demand sensing request at arrow 1125. This capability may include any or all of the capabilities previously described (e.g., on-demand capability, maximum power, maximum bandwidth, etc.).

FIG. 11B shows an example of a second option which the on-demand sensing request is triggered at the sensing server, as shown at block 1145. Here, the process can proceed in a manner as shown in FIG. 6, with the addition of the capability exchange between the sensing server 1115 and base station 1110. More specifically, the sensing server 1115 sends a capability query (arrow 1150) to the base station 1110 to request the on-demand sensing capabilities of the base station 1110 and/or sensing node(s) 1105. The base station 1110 can then respond with capability reporting (arrow 1155), providing the requested capabilities. Capabilities of sensing node(s) 1105 may be provided to the base station 1110 by the sensing node(s) 1105 at an earlier time (not shown in FIG. 11B), such as when the sensing node(s) 1105 initially establish a data connection with the base station 1110 and/or in response to a request from the base station 1110.

FIG. 11 C shows an example of a third option in which the on-demand sensing request is again triggered at the sensing server, shown at block 1145. Here, however, there is not a separate exchange of capability, but instead a modified configuration request of sensing RS sent from the sensing server 1115 to the base station 1110 (shown by arrow 1160) includes a capability query. This capability query may assume certain capabilities of the base station 1110 and/or sensing node(s) 1105, which, the base station 1110 can confirm in the ACK sent at arrow 1135. In other words, the ACK received at 1135 may verify the assumed capabilities included in the modified configuration request at arrow 1160. On the other hand, if the base station 1110 is unable to provide an ACK message to confirm the assumed capabilities, it can indicate to the sensing server 1115 that the base station 1110 and/or sensing node(s) 1105 cannot support on-demand sensing or that the assumed on-demand sensing capabilities exceed those of the base station 1110 and/or sensing node(s) 1105.

According to some embodiments, on-demand sensing requests may provide a large amount of flexibility in the way in which RF sensing is performed. As previously noted, and on-demand sensing request may include various parameters (e.g., requested or required parameters) for performing on-demand sensing. According to some embodiments, this may include a specific beam operation in the request. For example, an on-demand sensing request (e.g., generated at a sensing node or a sensing server) may (i) request the beam for specific target area; (ii) request a specific sequential beams (e.g., indicating a transmit time and/or sequence for each beam); (iii) cancel some beams that is not UE's interest; or any combination thereof. According to some embodiments, a default sensing configuration may comprise beam sweeping in all available directions.

Additionally or alternatively, according to some embodiments, an on-demand sensing request may include a specific Doppler in the request. For example, an on-demand sensing request (e.g., generated at a sensing node or a sensing server) may (i) request a sequential bundled sensing RS; and/or (ii) reduce the pruning range of the RS over time.

According to some embodiments, an on-demand sensing request may include a waveform/sensing RS pattern selection. For example, an on-demand sensing request (e.g., generated at a sensing node or a sensing server) may request any combination of a radar waveform, orthogonal frequency-division multiplexing (OFDM) waveform, single carrier (SC) waveform, or comb 1−N sensing RS pattern.

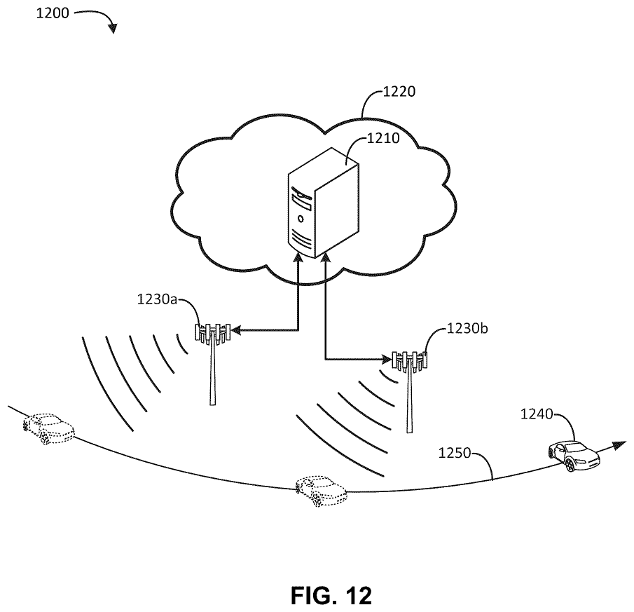

FIG. 12 is a diagram illustrating an example of how on-demand sensing may be performed in a particular scenario, according to some embodiments. In FIG. 12, a similar architecture 1200 exists to the architecture 200 in FIG. 2, a sensing server 1210 comprises part of the network 1220, and base stations 1230a and 1230b (collectively and generically referred to herein as base stations 1210) operate as both sensing nodes and accessing points, similar to the configuration 240 of FIG. 2. That said, additional or alternative configurations may be utilized in other scenarios, depending on available resources.

In the example of FIG. 12, a sensing server 1210 may be tasked to track a particular target 1240, which moves along a path 1250. As such, the sensing server 1210 may use historical and/or other information to determine that the target 1240 may first appear in a sensing area of a first base station 1230a. The sensing server 1210 can then initiate on-demand sensing by providing an on-demand sensing request, in which case the sensing server 1210 may interact with each base station 1230 to carry out the on-demand sensing (e.g., in a manner similar to the method shown in FIG. 7B). Given the flexibility of activating/deactivating certain beams, RS transmissions, etc., the sensing server 1210 can track the target 1240 as it moves along path 1250. This can include deactivating RF sensing by the first base station 1230a as the target moves out of the sensing area of the first base station 1230a, and activating by the second base station 1230b as the target moves into of the sensing area of the second base station 1230b. This can also comprise changing sensing power and/or beams at different base stations 1230 as the target 1240 moves through the sensing areas of base station 1230. Accordingly, the sensing server 1210 may have a large amount of flexibility in tracking a given target 1240 utilizing the various on-demand sensing capabilities of one or more sensing nodes.

As discussed in the various embodiments herein, a sensing server may be responsible for sensing management, including on-demand sensing as described herein. A base station can verify whether a desired/prospective RS sensing configuration, as received from the sensing server, can work with available wireless resources. This verification processes shown, for example, by messages exchanged at arrows 660 and 670 of FIG. 6.

The content included in the desired/prospective RS sensing configuration provided by the sensing server to the base station for verification can vary, depending on desired functionality. According to some embodiments, the content of the desired/prospective RS sensing configuration may include some or all of the information provided in the on-demand sensing request (e.g., from a sensing node or sensing server). According to some embodiments, the content may include a modified or updated version of the information in the on-demand sensing request. As noted, a sensing server may update or alter an on-demand sensing configuration based, for example, on other on-demand sensing requests, to help accommodate the scheduling for all requests.

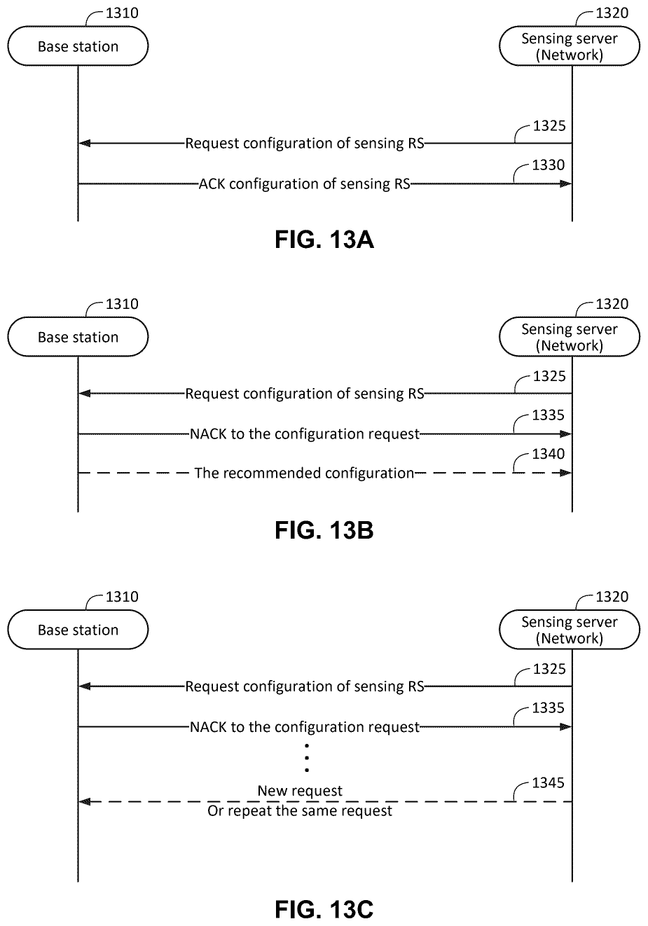

FIGS. 13A-13C are message flow diagrams illustrating different options for how this exchange between the base station 1310 and sensing server 1320 may be performed, according to some embodiments. FIG. 13A illustrates a basic option (shown in other diagrams herein, including arrows 660 and 670 of FIG. 6), in which the sensing server 1320 sends a request for the use of a desired/prospective RS configuration, at arrow 1325, to which the base station 1310 provides an acknowledgment, at arrow 1330. It can be noted that this exchange may be performed with one or more base stations 1310. Multiple base stations 1310 may be contacted if multiple base stations may be involved in the on-demand RF sensing. (More generally, any exchange in the embodiments described herein between a sensing server and a single base station may occur between the sensing server and multiple base stations if multiple base stations may be involved in the on-demand RF sensing.)

FIG. 13B illustrates an example of how a base station 1310 may respond if the desired/prospective RS configuration cannot be supported. In this case, the base station 1310 provides a negative acknowledgement (NACK), rather than an ACK, to the SMF, as shown by arrow 1335. Optionally, the base station can further provide an alternative recommended configuration, as shown by arrow 1340. For example, if the request at arrow 1325 indicates the sensing procedure at a particular time, but base station 1310 cannot enable the sensing at that time, the base station 1310 can provide the NAK at arrow 1335, and further indicate a recommended configuration at arrow 1340 with an alternative time for the sensing. In response, the sensing server 1320 can use the recommended alternative time for the on-demand RF sensing, or send a new request with a new desired/prospective RS configuration. FIG. 13C illustrates how multiple messages may be exchanged between the base station 1310 and sensing server 1320 (e.g., as shown by new/repeated request at arrow 1345) to determine an RS configuration to use for on-demand RF sensing.

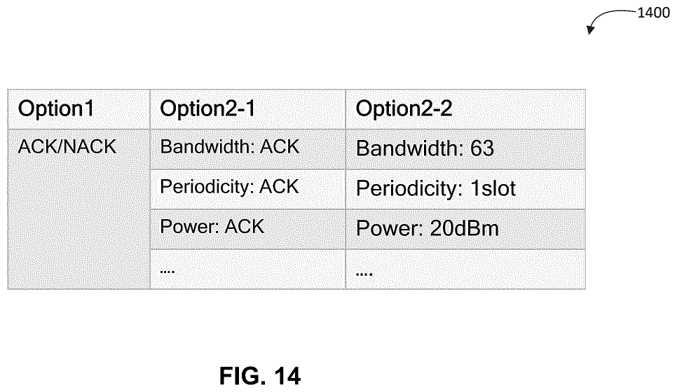

FIG. 14 is an illustration of a table 1400 showing an example of how the content of ACK/NACK messages provided by a base station to a sensing server, as described herein, may vary according to some embodiments. As can be seen, different options may provide different levels of information. In Option 1, for example, the message may comprise a simple ACK or NACK of the desired/prospective RS configuration. Although this utilizes little overhead, this option provides little information. It could be, for example, that only one parameter of the desired/prospective RS configuration is unable to be met, but all other parameters may be fine.

With this in mind, a second option may be provided for addressing each parameter in the configuration. This second option may be split into options 2-1 and 2-2, as shown in the table 1400. Option 2-1 allows for a line item ACK/NACK. That is, the base station can provide an ACK/NACK response to each parameter of the desired/prospective RS configuration (which may include, for example, bandwidth, periodicity, power, etc.). By identifying particular parameters that cannot be met, this can help facilitate adjustment of the desired/prospective RS configuration by the sensing server. Alternatively, according to Option 2-2, specific parameter values for a new RS configuration may be provided. These specific parameter values may represent values that can be supported by the base station and sensing nodes. These may reflect the values in the desired/prospective RS configuration and/or, in instances where such values in the desired/prospective RS configuration cannot be met, values that can be supported by the base station and sensing nodes that are closest to the desired/prospective RS configuration values. In instances in which an on-demand configuration is based on a sensor server-initiated on-demand request, the sensor server may configure one overall sensing resource (e.g., a common configuration) to all sensing nodes participating in the RF sensing.

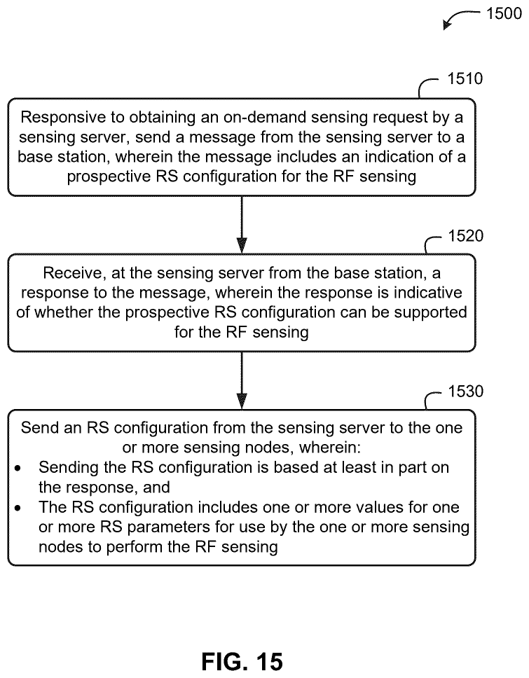

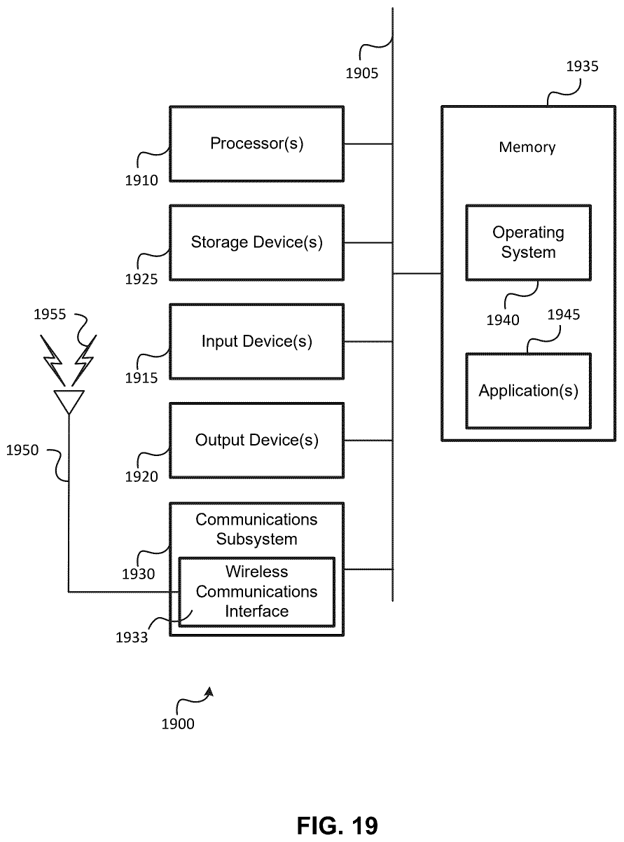

FIG. 15 is a flow diagram of a method 1500 of enabling on-demand RF sensing by one or more sensing nodes, according to an embodiment. This functionality may reflect the functionality of the sensing server in the previously-described embodiments. As such, means for performing the functionality illustrated in one or more of the blocks shown in FIG. 15 may be performed by hardware and/or software components of a sensing server. Example components of a computer system that could be used as a sensing server are illustrated in FIG. 19, which is described in more detail below. As noted herein, a sensing server may comprise an SMF (e.g., in a cellular network), according to some embodiments.

At block 1510, the functionality comprises responsive to obtaining an on-demand sensing request at a sensing server, sending a message from the sensing server to a base station, wherein the message includes an indication of a prospective RS configuration for the RF sensing. This message may correspond to the request indicated at arrow 660 of FIG. 6, and/or counterparts in FIGS. 7A, 7B, 8, 11A-11C, and 13A-13C, as described herein. As described in the embodiments herein, an on-demand sensing request may be provided by a sensing node or the sensing server. As such, according to some embodiments of the method 1500, obtaining the on-demand sensing request by the sensing server may comprise receiving the on-demand sensing request from the one or more sensing nodes, or generating the on-demand sensing request at the sensing server. Further, as previously noted, the one or more sensing nodes may comprise the base station, in some embodiments. Means for performing functionality at block 1510 may comprise a bus 1905, processor(s) 1910, communications subsystem 1930, memory 1935, and/or other components of a computer system 1900, as illustrated in FIG. 19.

At block 1520, the functionality comprises receiving, at the sensing server from the base station, a response to the message, wherein the response is indicative of whether the prospective RS configuration can be supported for the RF sensing. This functionality may correspond to the functionality indicated at arrow 670 of FIG. 6, and/or counterparts in FIGS. 7A, 7B, 8, 11A-11C, and 13A-13C, as described herein. As previously described with respect to FIGS. 14 and 15, the content of the response to the message can vary, depending on capabilities and desired functionality. For example, in some embodiments, the response to the message may include an ACK, the ACK indicating the prospective RS configuration can be supported. In some embodiments, the response to the message may include a NACK, the NACK indicating the prospective RS configuration cannot be supported. In such embodiments, the method 1500 may further comprise, responsive to the NACK, sending a new prospective RS configuration from the sensing server to the base station. The new prospective RS configuration may include modifications to the prospective RS configuration based on receiving a NACK or an alternative value for an RS configuration parameter. According to some embodiments, the prospective RS configuration includes one or more prospective values for the one or more RS parameters. In such embodiments, the response to the message may comprise, for each of the one or more prospective values: (i) an indication of whether the respective prospective value can be supported, or (ii) a supported value comprising either: respective prospective value, or an alternative value for the respective prospective value. Means for performing functionality at block 1520 may comprise a bus 1905, processor(s) 1910, communications subsystem 1930, memory 1935, and/or other components of a computer system 1900, as illustrated in FIG. 19.

At block 1530, the functionality comprises sending an RS configuration from the sensing server to the one or more sensing nodes, wherein sending the RS configuration is based at least in part on the response, and the RS configuration includes one or more values for one or more RS parameters for use by the one or more sensing nodes to perform the RF sensing. This functionality may correspond to the functionality indicated at arrow 680 of FIG. 6, and/or counterparts in FIGS. 7A, 7B, 8, 11A-11C, and 13A-13C, as described herein. As previously indicated, values for the one or more RS parameters may be based on recommended/requested/required values provided in the on-demand request. As such, for some embodiments of the method 1500 may comprise the on-demand sensing request may include one or more requested values for the one or more RS parameters. The one or more RS parameters comprise: a bandwidth for RS used in the RF sensing, a periodicity for RS used in the RF sensing, a sensing power for RS used in the RF sensing, a sensing window for RS used in the RF sensing, a beam for RS used in the RF sensing, or a combination thereof.

As previously described with respect to FIGS. 10A and 10 B, an on-demand sensing request may utilize periodic, semi-persistent, or a periodic RS. As such, according to some embodiments of the method 1500, the on-demand sensing request may comprise a request to activate transmission of periodic or semi-persistent RS. additionally or alternatively, the on-demand sensing request may comprise a request to activate transmission of aperiodic RS. In such embodiments utilizing aperiodic RS, the on-demand sensing request further comprises values for: a power for the aperiodic RS, a periodicity for the aperiodic RS, a start time for the aperiodic RS, an end time for the aperiodic RS, or a combination thereof.

As described herein, embodiments may allow for a capability exchange between a sensing server and base station. As such, according to some embodiments of the method 1500, obtaining the on-demand sensing request by the sensing server may comprise receiving the on-demand sensing request from the one or more sensing nodes, and wherein the on-demand sensing request May include information regarding one or more capabilities of the one or more sensing nodes for performing the RF sensing. Additionally or alternatively, embodiments may include, prior to sending the RS configuration: sending a capability query to the base station, and receiving a capability reporting from the base station, wherein the capability reporting includes information regarding one or more capabilities of the one or more sensing nodes for performing the RF sensing.

Means for performing functionality at block 1530 may comprise a bus 1905, processor(s) 1910, communications subsystem 1930, memory 1935, and/or other components of a computer system 1900, as illustrated in FIG. 19.

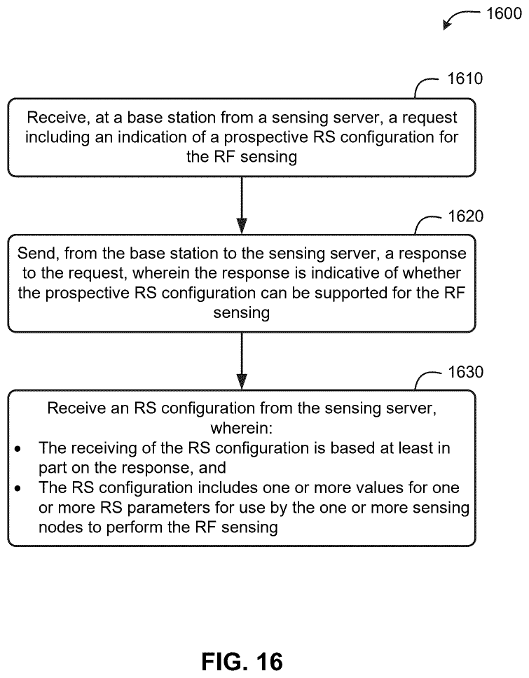

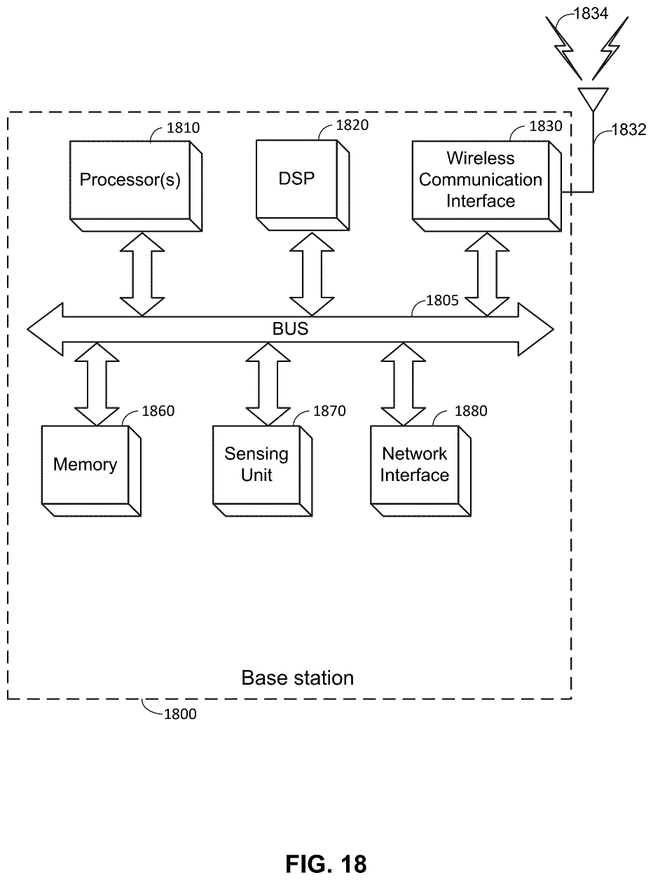

FIG. 16 is a flow diagram of another method 1600 of enabling on-demand RF sensing by one or more sensing nodes, according to an embodiment. This functionality may reflect the functionality of the base station in the previously-described embodiments. As such, means for performing the functionality illustrated in one or more of the blocks shown in FIG. 16 may be performed by hardware and/or software components of a base station. Example components of a base station are illustrated in FIG. 18, which is described in more detail below.

At block 1610, the functionality comprises receiving, at a base station from a sensing server, a message including an indication of a prospective reference signal (RS) configuration for the RF sensing. As noted with respect to FIG. 15, this functionality may correspond to the functionality indicated at arrow 660 of FIG. 6, and/or counterparts in FIGS. 7A, 7B, 8, 11A-11C, and 13A-13C, as described herein. As described in the embodiments herein, receiving of the message from the sensing server may be in response to the sensing server obtaining an on-demand sensing request, which may be received by a sensing node or generated by the sensing server. According to some embodiments, the one or more sensing nodes may comprise the base station, in which case the method 1600 may further comprise, prior to receiving the message, sending an on-demand sensing request from the base station to the sensing server. According to some embodiments, the on-demand sensing request includes one or more requested values for the one or more RS parameters. Means for performing functionality at block 1610 may comprise a bus 1805, processor(s) 1810, digital signal processor (DSP) 1820, wireless communication interface 1830, memory 1860, and/or other components of a base station 1800, as illustrated in FIG. 19.

At block 1620, the functionality comprises sending, from the base station to the sensing server, a response to the message, wherein the response is indicative of whether the prospective RS configuration can be supported for the RF sensing. This functionality may correspond to the functionality indicated at arrow 670 of FIG. 6, and/or counterparts in FIGS. 7A, 7B, 8, 11A-11C, and 13A-13C, as described herein. As previously described with respect to FIGS. 14 and 15, the content of the response to the message can vary, depending on capabilities and desired functionality. For example, in some embodiments, the response to the message may include an ACK, the ACK indicating the prospective RS configuration can be supported. In some embodiments, the response to the message may include a NACK, the NACK indicating the prospective RS configuration cannot be supported. In such embodiments, the method 1500 may further comprise, responsive to the NACK, sending a new prospective RS configuration from the sensing server to the base station. The new prospective RS configuration may include modifications to the prospective RS configuration based on receiving a NACK or an alternative value for an RS configuration parameter. According to some embodiments, the prospective RS configuration includes one or more prospective values for the one or more RS parameters. In such embodiments, the response to the message may comprise, for each of the one or more prospective values: (i) an indication of whether the respective prospective value can be supported, or (ii) a supported value comprising either: respective prospective value, or an alternative value for the respective prospective value.

Means for performing functionality at block 1620 may comprise a bus 1805, processor(s) 1810, digital signal processor (DSP) 1820, wireless communication interface 1830, memory 1860, and/or other components of a base station 1800, as illustrated in FIG. 19.

At block 1630, the functionality comprises receiving an RS configuration from the sensing server, wherein: the receiving of the RS configuration is based at least in part on the response, and the RS configuration includes one or more values for one or more RS parameters for use by the one or more sensing nodes to perform the RF sensing. In instances in which the one or more sensing nodes comprise the base station, the method may comprise using the RS configuration to perform the RF sensing with the base station. On the other hand, in cases in which the one or more sensing nodes do not comprise the base station, the method may further comprise relaying the RS configuration to the one or more sensing nodes.

Means for performing functionality at block 1630 may comprise a bus 1805, processor(s) 1810, digital signal processor (DSP) 1820, wireless communication interface 1830, memory 1860, and/or other components of a base station 1800, as illustrated in FIG. 19.

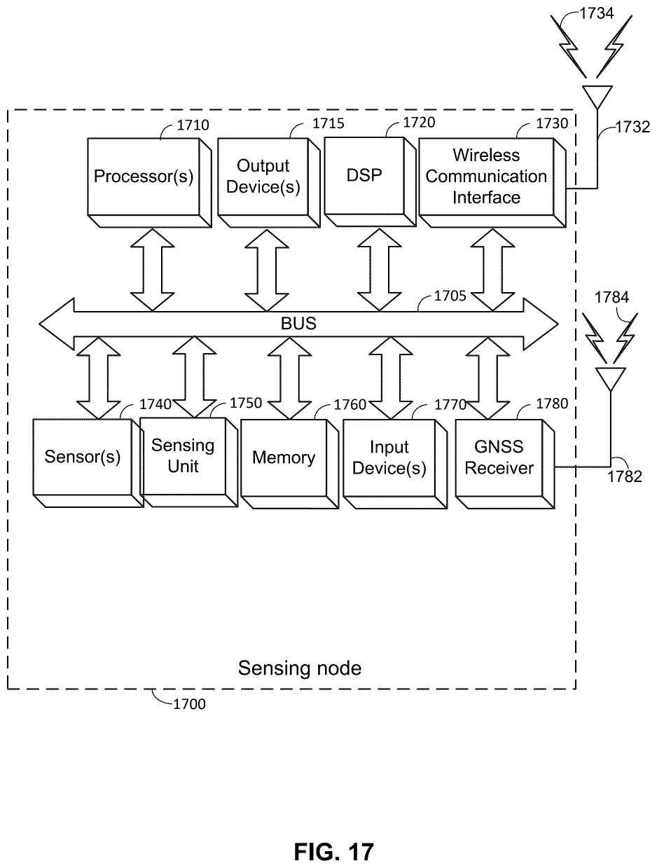

FIG. 17 is a block diagram of an embodiment of a sensing node 1700, which can be utilized as described herein (e.g., in association with the previously-described figures), for performing RF sensing. In some embodiments, for example, the sensing node 1700 may comprise, for example, a mobile (e.g., movable/portable) device (e.g., UE, tablet, laptop, vehicle, etc.). In some embodiments, the sensing node 1700 may comprise a fixed (e.g., immobile) electronic device. It should be noted that FIG. 17 is meant only to provide a generalized illustration of various components, any or all of which may be utilized as appropriate. Furthermore, the functionality of the sensing nodes discussed herein may be executed by one or more of the hardware and/or software components illustrated in FIG. 17. As noted, a base station may comprise a sensing node. An thus, some or all of the components of FIG. 17 may be incorporated into a base station. That said, a base station may have different components, as illustrated in FIG. 18 and described hereafter.

The sensing node 1700 is shown comprising hardware elements that can be electrically coupled via a bus 1705 (or may otherwise be in communication, as appropriate). The hardware elements may include a processor(s) 1710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1710 may comprise one or more processing units, which may be housed in a single integrated circuit (IC) or multiple ICs. As shown in FIG. 17, some embodiments may have a separate DSP 1720, depending on desired functionality. Location determination and/or other determinations based on wireless communication may be provided in the processor(s) 1710 and/or wireless communication interface 1730 (discussed below). The sensing node 1700 also can include one or more input devices 1770, which can include without limitation one or more keyboards, touch screens, touch pads, microphones, buttons, dials, switches, and/or the like; and one or more output devices 1715, which can include without limitation one or more displays (e.g., touch screens), light emitting diodes (LEDs), speakers, and/or the like.

The sensing node 1700 may also include a wireless communication interface 1730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the sensing node 1700 to communicate with other devices as described in the embodiments above. The wireless communication interface 1730 may permit data and signaling to be communicated (e.g., transmitted and received) with base stations of a network, for example, via eNBs, gNBs, ng-eNBs, access points, various base stations and/or other access node types, and/or other network components, computer systems, and/or any other electronic devices communicatively coupled with base stations, as described herein. The communication can be carried out via one or more wireless communication antenna(s) 1732 that send and/or receive wireless signals 1734. According to some embodiments, the wireless communication antenna(s) 1732 may comprise a plurality of discrete antennas, antenna arrays, or any combination thereof. The antenna(s) 1732 may be capable of transmitting and receiving wireless signals using beams (e.g., Tx beams and Rx beams). Beam formation may be performed using digital and/or analog beam formation techniques, with respective digital and/or analog circuitry. The wireless communication interface 1730 may include such circuitry.

Depending on desired functionality, the wireless communication interface 1730 may comprise a separate receiver and transmitter, or any combination of transceivers, transmitters, and/or receivers to communicate with base stations (e.g., ng-eNBs and gNBs) and other terrestrial transceivers, such as wireless devices and access points. The sensing node 1700 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The sensing node 1700 can further include sensor(s) 1740. Sensor(s) 1740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the sensing node 1700 may further comprise a sensing unit 1750. The sensing unit 1750 may comprise hardware and/or software components capable of transmitting and/or receiving RF signals (e.g., RS) to detect one or more targets in the manner described herein. The sensing unit 1750 may comprise a standalone component connected with a bus 1705, as illustrated, or may be incorporated into another component (e.g., the wireless indication interface 1730). Further, the sensing unit 1750 may be communicatively coupled with an antenna 1732, which it may share with the wireless communication interface 1730. Additionally or alternatively, the sensing unit 1750 may have its own antenna (not shown). In some embodiments the sensing unit 1750 may be communicatively coupled with multiple antennas or an antenna array capable of sending and/or receiving RF signals via directional beams.

Embodiments of the sensing node 1700 may also include a Global Navigation Satellite System (GNSS) receiver 1780 capable of receiving signals 1784 from one or more GNSS satellites using an antenna 1782 (which could be the same as antenna 1732). Positioning based on GNSS signal measurement can be utilized to complement and/or incorporate the techniques described herein. The GNSS receiver 1780 can extract a position of the sensing node 1700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1780 is illustrated in FIG. 17 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1710, DSP 1720, and/or a processor within the wireless communication interface 1730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1710 or DSP 1720.

The sensing node 1700 may further include and/or be in communication with a memory 1760. The memory 1760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1760 of the sensing node 1700 also can comprise software elements (not shown in FIG. 17), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1760 that are executable by the sensing node 1700 (and/or processor(s) 1710 or DSP 1720 within sensing node 1700). In some embodiments, then, such code and/or instructions can be used to configure and/or adapt a general-purpose computer (or other device) to perform one or more operations in accordance with the described methods.

FIG. 18 is a block diagram of an embodiment of a base station 1800, which can be utilized as described herein above, with respect to base stations and/or Transmission Reception Point (TRPs). It should be noted that FIG. 18 is meant only to provide a generalized illustration of various components, any or all of which may be utilized as appropriate. In some embodiments, the base station 1800 may correspond to a gNB, an ng-eNB, and/or (more generally) a TRP. In some cases, a base station 1800 may comprise multiple TRPs—e.g. with each TRP associated with a different antenna or a different antenna array of the base station 1800 (e.g., 1832). As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP.

The functionality performed by a base station 1800 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. The functionality of these functional components may be performed by one or more of the hardware and/or software components illustrated in FIG. 18.

The base station 1800 is shown comprising hardware elements that can be electrically coupled via a bus 1805 (or may otherwise be in communication, as appropriate). The hardware elements may include a processor(s) 1810 which can include without limitation one or more general-purpose processors, one or more special-purpose processors (such as digital signal processor (DSP) chips, graphics acceleration processors, application-specific integrated circuits (ASICs), and/or the like), and/or other processing structure or means. As shown in FIG. 18, some embodiments may have a separate DSP 1820, depending on desired functionality. Location determination and/or other determinations based on wireless communication may be provided in the processor(s) 1810 and/or wireless communication interface 1830 (discussed below), according to some embodiments. The base station 1800 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 1800 might also include a wireless communication interface 1830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 1800 to communicate as described herein. The wireless communication interface 1830 may permit data and signaling to be communicated (e.g., transmitted and received) to UEs, other base stations/TRPs (e.g., eNBs, gNBs, and ng-eNBs), and/or other network components, computer systems, and/or other electronic devices described herein. The communication can be carried out via one or more wireless communication antenna(s) 1832 that send and/or receive wireless signals 1834. According to some embodiments, one or more wireless communication antenna(s) 1832 may comprise one or more antenna arrays, which may be capable of beamforming.

Embodiments of the base station 1800 may further comprise a sensing unit 1870. The sensing unit 1870 may comprise hardware and/or software components capable of transmitting and/or receiving RF signals (e.g., RS) to detect one or more targets in the manner described herein. The sensing unit 1870 may comprise a standalone component connected with a bus 1805, as illustrated, or may be incorporated into another component (e.g., the wireless indication interface 1830). Further, the sensing unit 1870 may be communicatively coupled with an antenna 1832, which it may share with the wireless communication interface 1830. Additionally or alternatively, the sensing unit 1870 may have its own antenna (not shown). In some embodiments the sensing unit 1870 may be communicatively coupled with multiple antennas or an antenna array capable of sending and/or receiving RF signals via directional beams.

The base station 1800 may also include a network interface 1880, which can include support of wireline communication technologies. The network interface 1880 may include a modem, network card, chipset, and/or the like. The network interface 1880 may include one or more input and/or output communication interfaces to permit data to be exchanged with a network, communication network servers, computer systems, and/or any other electronic devices described herein.

In many embodiments, the base station 1800 may further comprise a memory 1860. The memory 1860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1860 of the base station 1800 also may comprise software elements (not shown in FIG. 18), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1860 that are executable by the base station 1800 (and/or processor(s) 1810 or DSP 1820 within base station 1800). In some embodiments, then, such code and/or instructions can be used to configure and/or adapt a general-purpose computer (or other device) to perform one or more operations in accordance with the described methods.

FIG. 19 is a block diagram of an embodiment of a computer system 1900, which may be used, in whole or in part, to provide the functions of one or more components and/or devices as described in the embodiments herein, including a server (e.g., sensing server/SMF) in communication with one or more base stations and/or one or more sensing nodes to coordinate RF sensing as described in embodiments herein. This may include, for example, a computer server, personal computer, personal electronic device, or the like. It should be noted that FIG. 19 is meant only to provide a generalized illustration of various components, any or all of which may be utilized as appropriate. FIG. 19, therefore, broadly illustrates how individual system elements may be implemented in a relatively separated or relatively more integrated manner. In addition, it can be noted that components illustrated by FIG. 19 can be localized to a single device and/or distributed among various networked devices, which may be disposed at different geographical locations.

The computer system 1900 is shown comprising hardware elements that can be electrically coupled via a bus 1905 (or may otherwise be in communication, as appropriate). The hardware elements may include processor(s) 1910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1900 also may comprise one or more input devices 1915, which may comprise without limitation a mouse, a keyboard, a camera, a microphone, and/or the like; and one or more output devices 1920, which may comprise without limitation a display device, a printer, and/or the like.

The computer system 1900 may further include (and/or be in communication with) one or more non-transitory storage devices 1925, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1900 may also include a communications subsystem 1930, which may comprise wireless communication technologies managed and controlled by a wireless communication interface 1933, as well as wired technologies (such as Ethernet, coaxial communications, universal serial bus (USB), and the like). The wireless communication interface 1933 may comprise one or more wireless transceivers that may send and receive wireless signals 1955 (e.g., signals according to 5G NR or LTE) via wireless antenna(s) 1950. Thus the communications subsystem 1930 may comprise a modem, a network card (wireless or wired), an infrared communication device, a wireless communication device, and/or a chipset, and/or the like, which may enable the computer system 1900 to communicate on any or all of the communication networks described herein to any device on the respective network, including a User Equipment (UE), base stations and/or other transmission reception points (TRPs), and/or any other electronic devices described herein. Hence, the communications subsystem 1930 may be used to receive and send data as described in the embodiments herein.

In many embodiments, the computer system 1900 will further comprise a working memory 1935, which may comprise a RAM or ROM device, as described above. Software elements, shown as being located within the working memory 1935, may comprise an operating system 1940, device drivers, executable libraries, and/or other code, such as one or more applications 1945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1925 described above. In some cases, the storage medium might be incorporated within a computer system, such as computer system 1900. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1900 and/or might take the form of source and/or installable code, which, upon compilation and/or installation on the computer system 1900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of enabling on-demand radio frequency (RF) sensing by one or more sensing nodes, the method comprising: responsive to obtaining an on-demand sensing request at a sensing server, sending a message from the sensing server to a base station, wherein the message includes an indication of a prospective reference signal (RS) configuration for the RF sensing; receiving, at the sensing server from the base station, a response to the message, wherein the response is indicative of whether the prospective RS configuration can be supported for the RF sensing; and sending an RS configuration from the sensing server to the one or more sensing nodes, wherein: sending the RS configuration is based at least in part on the response, and the RS configuration includes one or more values for one or more RS parameters for use by the one or more sensing nodes to perform the RF sensing.
Clause 2. The method of clause 1, wherein obtaining the on-demand sensing request by the sensing server comprises: receiving the on-demand sensing request from the one or more sensing nodes, or generating the on-demand sensing request at the sensing server.
Clause 3. The method of any one of clauses 1-2 wherein the one or more sensing nodes comprise the base station.
Clause 4. The method of any one of clauses 1-3 wherein the on-demand sensing request includes one or more requested values for the one or more RS parameters.
Clause 5. The method of any one of clauses 1-4 wherein the one or more RS parameters comprise: a bandwidth for RS used in the RF sensing, a periodicity for RS used in the RF sensing, a sensing power for RS used in the RF sensing, a sensing window for RS used in the RF sensing, a beam for RS used in the RF sensing, or a combination thereof.
Clause 6. The method of any one of clauses 1-5 wherein the on-demand sensing request comprises a request to activate transmission of periodic or semi-persistent RS.
Clause 7. The method of any one of clauses 1-6 wherein the on-demand sensing request comprises a request to activate transmission of aperiodic RS.
Clause 8. The method of clause 7 wherein the on-demand sensing request further comprises values for: a power for the aperiodic RS, a periodicity for the aperiodic RS, a start time for the aperiodic RS, an end time for the aperiodic RS, or a combination thereof.
Clause 9. The method of any one of clauses 1-8 wherein obtaining the on-demand sensing request by the sensing server comprises receiving the on-demand sensing request from the one or more sensing nodes, and wherein the on-demand sensing request includes information regarding one or more capabilities of the one or more sensing nodes for performing the RF sensing.
Clause 10. The method of any one of clauses 1-9 further comprising, prior to sending the RS configuration sending a capability query to the base station, and receiving a capability reporting from the base station, wherein the capability reporting includes information regarding one or more capabilities of the one or more sensing nodes for performing the RF sensing.
Clause 11. The method of any one of clauses 1-10 wherein the response to the message includes an acknowledgement (ACK), the ACK indicating the prospective RS configuration can be supported.
Clause 12. The method of any one of clauses 1-10 wherein the response to the message includes a negative acknowledgement (NACK), the NACK indicating the prospective RS configuration cannot be supported, wherein the method further comprises, responsive to the NACK, sending a new prospective RS configuration from the sensing server to the base station.
Clause 13. The method of any one of clauses 1-12 wherein the prospective RS configuration includes one or more prospective values for the one or more RS parameters; and the response to the message comprises, for each of the one or more prospective values: an indication of whether the respective prospective value can be supported, or a supported value comprising either: respective prospective value, or an alternative value for the respective prospective value.
Clause 14. The method of any one of clauses 1-13 wherein the sensing server comprises a sensing management function (SMF).
Clause 15. A method of enabling on-demand radio frequency (RF) sensing by one or more sensing nodes, the method comprising: receiving, at a base station from a sensing server, a message including an indication of a prospective reference signal (RS) configuration for the RF sensing; sending, from the base station to the sensing server, a response to the message, wherein the response is indicative of whether the prospective RS configuration can be supported for the RF sensing; and receiving an RS configuration from the sensing server, wherein: the receiving of the RS configuration is based at least in part on the response, and the RS configuration includes one or more values for one or more RS parameters for use by the one or more sensing nodes to perform the RF sensing.
Clause 16. The method of clause 15, wherein the one or more sensing nodes comprise the base station, and wherein the method further comprises, prior to receiving the message, sending an on-demand sensing request from the base station to the sensing server.
Clause 17. The method of clause 16 wherein the on-demand sensing request includes one or more requested values for the one or more RS parameters.
Clause 18. The method of clause 15 wherein the one or more sensing nodes do not comprise the base station, and wherein the method further comprises relaying the RS configuration to the one or more sensing nodes.
Clause 19. The method of any one of clauses 15-18 wherein the response to the message includes either: an acknowledgement (ACK), the ACK indicating the prospective RS configuration can be supported, or a negative acknowledgement (NACK), the NACK indicating the prospective RS configuration cannot be supported.
Clause 20. The method of any one of clauses 15-19 wherein the prospective RS configuration includes one or more prospective values for the one or more RS parameters; and the response to the message comprises, for each of the one or more prospective values: an indication of whether the respective prospective value can be supported, or a supported value comprising either: respective prospective value, or an alternative value for the respective prospective value.
Clause 21. A sensing server comprising: a transceiver; a memory; and one or more processors communicatively coupled with the transceiver and the memory, wherein the one or more processors are configured to: responsive to obtaining an on-demand sensing request, send a message via the transceiver to a base station, wherein the message includes an indication of a prospective reference signal (RS) configuration for radio frequency (RF) sensing; receive, via the transceiver from the base station, a response to the message, wherein the response is indicative of whether the prospective RS configuration can be supported for the RF sensing; and send an RS configuration via the transceiver to one or more sensing nodes, wherein: sending the RS configuration is based at least in part on the response, and the RS configuration includes one or more values for one or more RS parameters for use by the one or more sensing nodes to perform the RF sensing.
Clause 22. The sensing server of clause 21, wherein, to obtain the on-demand sensing request, the one or more processors are configured to: receive the on-demand sensing request from the one or more sensing nodes, or generate the on-demand sensing request at the sensing server.
Clause 23. The sensing server of any one of clauses 21-22 wherein to send the RS configuration to one or more sensing nodes, the one or more processors are configured to send the RS configuration to the base station.
Clause 24. The sensing server of any one of clauses 21-23 wherein to include the one or more values for one or more RS parameters in the RS configuration, the one or more processors are configured to include values for: a bandwidth for RS used in the RF sensing, a periodicity for RS used in the RF sensing, a sensing power for RS used in the RF sensing, a sensing window for RS used in the RF sensing, a beam for RS used in the RF sensing, or a combination thereof.
Clause 25. The sensing server of any one of clauses 21-24 wherein the one or more processors are further configured to, prior to sending the RS configuration: send a capability query to the base station, and receive a capability reporting from the base station, wherein the capability reporting includes information regarding one or more capabilities of the one or more sensing nodes for performing the RF sensing.
Clause 26. The sensing server of any one of clauses 21-25 wherein the sensing server comprises a sensing management function (SMF).
Clause 27. A base station comprising: a transceiver; a memory; and one or more processors communicatively coupled with the transceiver and the memory, wherein the one or more processors are configured to: receive, via the transceiver from a sensing server, a message including an indication of a prospective reference signal (RS) configuration for radio frequency (RF) sensing; send, via the transceiver to the sensing server, a response to the message, wherein the response is indicative of whether the prospective RS configuration can be supported for the RF sensing; and receive an RS configuration via the transceiver from the sensing server, wherein: the receiving of the RS configuration is based at least in part on the response, and the RS configuration includes one or more values for one or more RS parameters for use by one or more sensing nodes to perform the RF sensing.
Clause 28. The base station of clause 27, wherein the one or more sensing nodes comprise the base station, and wherein the one or more processors are further configured to, prior to receiving the message, send an on-demand sensing request from the base station to the sensing server.
Clause 29. The base station of clause 28 wherein the one or more processors are configured to include, in the on-demand sensing request, one or more requested values for the one or more RS parameters.
Clause 30. The base station of any one of clauses 27-29 wherein the one or more processors are configured to include, in the response to the message, either: an acknowledgement (ACK), the ACK indicating the prospective RS configuration can be supported, or a negative acknowledgement (NACK), the NACK indicating the prospective RS configuration cannot be supported.
Clause 31. An apparatus having means for performing the method of any one of clauses 1-20.
Clause 32. A non-transitory computer-readable medium storing instructions, the instructions comprising code for performing the method of any one of clauses 1-20.

1. A method of enabling on-demand radio frequency (RF) sensing by one or more sensing nodes, the method comprising:
responsive to obtaining an on-demand sensing request at a sensing server, sending a message from the sensing server to a base station, wherein the message includes an indication of a prospective reference signal (RS) configuration for the RF sensing;
receiving, at the sensing server from the base station, a response to the message, wherein the response is indicative of whether the prospective RS configuration can be supported for the RF sensing; and
sending an RS configuration from the sensing server to the one or more sensing nodes, wherein:
sending the RS configuration is based at least in part on the response, and
the RS configuration includes one or more values for one or more RS parameters for use by the one or more sensing nodes to perform the RF sensing.

2. The method of claim 1, wherein obtaining the on-demand sensing request by the sensing server comprises:
receiving the on-demand sensing request from the one or more sensing nodes, or generating the on-demand sensing request at the sensing server.

3. The method of claim 1, wherein the one or more sensing nodes comprise the base station.

4. The method of claim 1, wherein the on-demand sensing request includes one or more requested values for the one or more RS parameters, wherein the one or more RS parameters comprise:
a bandwidth for RS used in the RF sensing,
a periodicity for RS used in the RF sensing,
a sensing power for RS used in the RF sensing,
a sensing window for RS used in the RF sensing,
a beam for RS used in the RF sensing, or
a combination thereof.

5. (canceled)

6. The method of claim 1, wherein the on-demand sensing request comprises a request to activate transmission of periodic, or semi-persistent RS.

7. The method of claim 1, wherein the on-demand sensing request comprises a request to activate transmission of aperiodic RS, wherein the on-demand sensing request further comprises values for:
a power for the aperiodic RS,
a periodicity for the aperiodic RS,
a start time for the aperiodic RS,
an end time for the aperiodic RS, or
a combination thereof.

8. (canceled)

9. The method of claim 1, wherein obtaining the on-demand sensing request by the sensing server comprises receiving the on-demand sensing request from the one or more sensing nodes, and wherein the on-demand sensing request includes information regarding one or more capabilities of the one or more sensing nodes for performing the RF sensing.

10. The method of claim 1, further comprising, prior to sending the RS configuration:
sending a capability query to the base station, and
receiving a capability reporting from the base station, wherein the capability reporting includes information regarding one or more capabilities of the one or more sensing nodes for performing the RF sensing.

11. The method of claim 1, wherein the response to the message includes, either
an acknowledgement (ACK), the ACK indicating the prospective RS configuration can be supported, or
a negative acknowledgement (NACK), the NACK indicating the prospective RS configuration cannot be supported, wherein the method further comprises, responsive to the NACK, sending a new prospective RS configuration from the sensing server to the base station.

12. (canceled)

13. The method of claim 1, wherein:
the prospective RS configuration includes one or more prospective values for the one or more RS parameters; and
the response to the message comprises, for each of the one or more prospective values:
(i) an indication of whether the respective prospective value can be supported, or
(ii) a supported value comprising either:
respective prospective value, or
an alternative value for the respective prospective value.

14-20. (canceled)

21. A sensing server comprising:
a transceiver;
a memory; and
one or more processors communicatively coupled with the transceiver and the memory, wherein the one or more processors are configured to:
responsive to obtaining an on-demand sensing request, send a message via the transceiver to a base station, wherein the message includes an indication of a prospective reference signal (RS) configuration for radio frequency (RF) sensing;
receive, via the transceiver from the base station, a response to the message, wherein the response is indicative of whether the prospective RS configuration can be supported for the RF sensing; and
send an RS configuration via the transceiver to one or more sensing nodes, wherein:
sending the RS configuration is based at least in part on the response, and
the RS configuration includes one or more values for one or more RS parameters for use by the one or more sensing nodes to perform the RF sensing.

22. The sensing server of claim 21, wherein, to obtain the on-demand sensing request, the one or more processors are configured to:
receive the on-demand sensing request from the one or more sensing nodes, or generate the on-demand sensing request at the sensing server.

23. The sensing server of claim 21, wherein to send the RS configuration to one or more sensing nodes, the one or more processors are configured to send the RS configuration to the base station.

24. The sensing server of claim 21, wherein to include the one or more values for one or more RS parameters in the RS configuration, the one or more processors are configured to include values for:
a bandwidth for RS used in the RF sensing,
a periodicity for RS used in the RF sensing,
a sensing power for RS used in the RF sensing,
a sensing window for RS used in the RF sensing,
a beam for RS used in the RF sensing, or
a combination thereof.

25. The sensing server of claim 21, wherein the one or more processors are further configured to, prior to sending the RS configuration:
send a capability query to the base station, and
receive a capability reporting from the base station, wherein the capability reporting includes information regarding one or more capabilities of the one or more sensing nodes for performing the RF sensing.

26. The sensing server of claim 21, wherein the sensing server comprises a sensing management function (SMF).

27. A base station comprising:
a transceiver;
a memory; and
one or more processors communicatively coupled with the transceiver and the memory, wherein the one or more processors are configured to:
receive, via the transceiver from a sensing server, a message including an indication of a prospective reference signal (RS) configuration for radio frequency (RF) sensing;
send, via the transceiver to the sensing server, a response to the message, wherein the response is indicative of whether the prospective RS configuration can be supported for the RF sensing; and
receive an RS configuration via the transceiver from the sensing server, wherein:
the receiving of the RS configuration is based at least in part on the response, and
the RS configuration includes one or more values for one or more RS parameters for use by one or more sensing nodes to perform the RF sensing.

28. The base station of claim 27, wherein the one or more sensing nodes comprise the base station, and wherein the one or more processors are further configured to, prior to receiving the message, send an on-demand sensing request from the base station to the sensing server.

29. The base station of claim 28, wherein the one or more processors are configured to include, in the on-demand sensing request, one or more requested values for the one or more RS parameters.

30. The base station of claim 27, wherein the one or more processors are configured to include, in the response to the message, either:
an acknowledgement (ACK), the ACK indicating the prospective RS configuration can be supported, or
a negative acknowledgement (NACK), the NACK indicating the prospective RS configuration cannot be supported.
